(19) United States
(12) Patent Application Publication
(10) Pub. No.: US 2002/0166275 A1
(43) Pub. Date: Nov. 14, 2002

(54) Universal sign holder

(75) Inventors: David G. Broadwell, Fort Lauderdale, FL (US); Gregg Pospisil, Oak Brook, IL (US)

Correspondence Address: HOLLAND & KNIGHT, LLP, ONE EAST BROWARD BLVD., SUITE 1300, FT LAUDERDALE, FL, 33301

(73) Assignee: The Sports Authority, Inc.

(21) Appl. No.: 10/142,602

(22) Filed: May 10, 2002

Related U.S. Application Data
(60) Provisional application No. 60/290,514, filed on May 11, 2001.

(51) Int. Cl. G09F 15/00; G09F 7/02

(52) U.S. Cl. 40/606; 40/611; 40/665

(57) ABSTRACT

A universal sign holder comprises a frame including a wall defining a hollow interior along which grooves are formed to receive and support a sign. The outer surfaces of the wall of the frame are formed with opposed channels which receive a multi-purpose adapter slidable within the channels to any position along the frame. The adapter mounts one end of a connector or post, the other end of which is connected to one of a number of individual fixtures each designed to mount to a particular type of merchandise display such as a rack, shelf, pegboard and the like.

This application claims priority under 35 U.S.C. § 119(e) to U.S. Provisional application Ser. No. 60/290,514 for all commonly disclosed subject matter. U.S. Provisional Application Ser. No. 60/290,514 is expressly incorporated herein by reference in its entirety to form a part of the present disclosure

### FIELD OF THE INVENTION

This invention relates to devices to mount signs, and, more particularly, to a sign holder capable of mounting a sign at selected orientations to a number of different types of merchandise displays such as shelves, pegboards, jet rail displays and others.

### BACKGROUND OF THE INVENTION

An important aspect of the merchandising of products in retail outlets is the display of items in a visually attractive and organized manner. Depending on the size and nature of the merchandise, display units take the form of shelves, racks, sections of pegboard and other structures. In order to draw the attention of customers to sale items and other products of interest, signs are typically employed which are positioned on or near the displays carrying the products.

There are a wide variety of sign holders currently in use which are designed to mount a sign in proximity to items carried on display units. One common type of sign holder includes a square or rectangular frame connected to a peg or shaft, which, in turn, is mounted to a base. A plastic or cardboard sign is inserted within grooves or other mounting structure on the frame, and the sign holder is then placed on a shelf or elsewhere near the items to be sold. Display units of this general type are disclosed, for example, in U.S. Pat. Nos. 5,911,523 to Burchart, 5,906,064 to Field, 4,777,750 to Garfinkle, 4,134,222 to Orsos and 2,070,652 to Elmer.

A variety of other merchandise displays are employed in retail outlets to draw customer attention to items for sale, and different structures have been designed to mount signs on or near such displays. For example, the Garfinkle patent noted above discloses a clip support intended to mount to the edge of a shelf, and a fixture designed to connect to a pegboard. A sign holder is connected to the clip or fixture in order to position a sign near the products on display. Magnetic supports are also in common use to mount sign holders in proximity to shelves or other metal structures. Additionally, there are a wide variety of racks designed to mount clothing and other items, each of which include bars, rails or arms for receiving hangars or other supports for the merchandise. Rail clips and other supports are commonly employed to secure signs to these types of merchandise displays.

It is not uncommon for a single retailer to use a large number of merchandise displays of different types to effectively market its products in a visually attractive manner. As such, a combination of racks, shelving, pegboard and other merchandise displays are often used in a single location. Although sign holders have been designed for use with virtually all kinds of displays, each individual sign holder is characteristically intended to mount to only one type of display. This requires the retailer to purchase and inventory a separate group of sign holders for each type of merchandise display in the store, which is expensive both in terms of the initial purchase price and the cost of separately storing all of the different holders when not in use.

### SUMMARY OF THE INVENTION

It is therefore among the objectives of this invention to provide a sign holder which is capable of use with merchandise displays of different types, which is versatile, which is easy to assemble and disassemble, and, which is economic to purchase and inventory.

These objectives are accomplished in a universal sign holder comprising a frame including a wall defining a hollow interior along which grooves are formed to receive and support a sign. The outer surfaces of the wall of the frame are formed with opposed channels which receive a multi-purpose adapter slidable within the channels to any position along the frame. The adapter mounts one end of a connector or post, the other end of which is connected to one of a number of individual fixtures each designed to mount to a particular type of merchandise display such as a rack, shelf, pegboard and the like. The adapter and fixtures are effective to position the frame so that the sign can be located in close proximity to a merchandise display.

In the presently preferred embodiment, the adapter is formed with a base connected to opposed walls each of which has at least one tab extending toward the opposite wall. A socket is formed within the interior of the adapter, one end of which is open and the other closed. The closed end of the socket is spaced from the tabs a distance approximately equal to the thickness of the wall of the frame so that when the tabs enter the channels in the frame wall, the closed end of the socket frictionally engages the wall to retain the adapter on the frame. The open end of the socket receives the connector or post, which extends into a sleeve formed in each of the fixtures. The fixtures, in turn, each mount to a different type of merchandise display.

An important aspect of this invention is its versatility. With the sign holder herein, it is convenient and easy to mount the frame and its sign to essentially any type of display unit. This eliminates the need for the retailer to purchase and stock a number of different types of sign holders, thus reducing costs and simplifying the placement of signs throughout a store.

### DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a perspective view of the universal sign holder of this invention including a shovel base;

FIG. 2 is a front elevational view of the sign holder shown in FIG. 1;

FIG. 2A is a cross sectional view taken generally along line 2A-2A of FIG. 2;

FIG. 2B is a cross sectional view taken generally along line 2B-2B of FIG. 2;

FIG. 3 is a perspective view, including hidden lines, depicting the adaptor including mounting straps;

FIG. 4 is a top plan view of FIG. 3;

FIG. 5 is a bottom plan view of FIG. 3;

FIG. 6 is an end view of the adaptor of FIG. 3 and the bottom portion of the frame depicting the interconnection of the tabs of the adaptor within the channels in the frame;

FIG. 7 is a perspective view of the magnetic fixture of this invention;

FIG. 8 is an end view, in partial cross section, of FIG. 7;

FIG. 9 is a perspective view of the jet rail fixture herein;

FIG. 10 is a side elevational view of FIG. 9;

FIG. 11 is a perspective view of the pegboard/slatwall fixture of this invention;

FIG. 12 is a side elevational view of FIG. 11; and

FIG. 13 is an elevational view of the connector posts.

### DETAILED DESCRIPTION OF THE INVENTION

Referring now to the drawings, the universal sign holder 10 of this invention includes a frame 12, an adapter 14, four different types of fixtures, namely, a shovel base 16, a magnetic fixture 18, a jet rail fixture 20, a pegboard/slatwall fixture 22, and, connectors 24, 26 and 28 of varying length. The frame 12 and adapter 14 are common to each embodiment of this invention, with the fixtures 16, 18, 20 and 22 being employed depending upon the type of merchandise display with which the sign holder 10 is used.

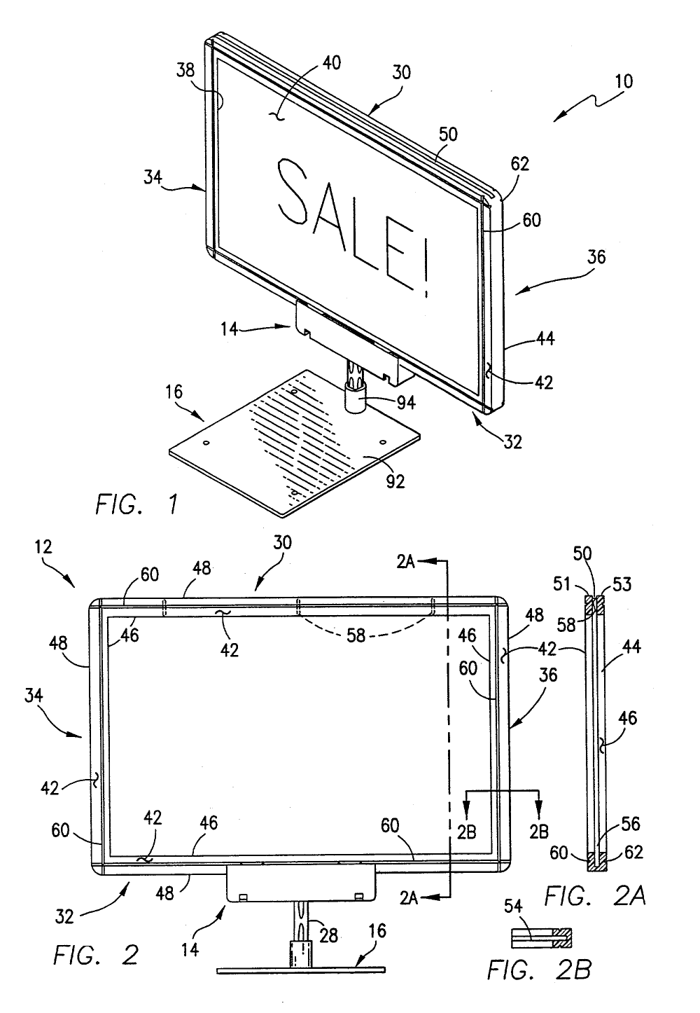

With reference initially to FIGS. 1-2B, in the presently preferred embodiment, the frame 12 is rectangular in shape having a top wall 30, a bottom wall 32 and opposed side walls 34 and 36. The walls are interconnected to define a hollow interior 38 within which a sign 40 is mounted as described below. Viewing the frame 12 in the position depicted in the Figs., each of the walls 30, 32, 34 and 36 has a front surface 42, a back surface 44, and inner surface 46 and an outer surface 48. The terms “top” and “bottom” as used herein refer to the vertical orientation of the frame 12 as it appears in FIG. 1. The term “inner” refers to the direction facing the hollow interior 38 of the frame 12, while “outer” denotes the opposite direction. As such, the front surface 42 and back surface 44 of each wall 30, 32, 34 and 36 extends between the inner and outer surfaces 46, 48 thereof.

The frame 12 is formed with structure to mount a sign 40 within its hollow interior 38. Preferably, the top wall 30 is formed with a slot 50 which divides it into two sections 51 and 53 except at the ends where the top wall 30 connects to the side walls 34 and 36. See FIG. 2A. The side walls 34 and 36 are each formed with a groove 54, only one of which is shown in the Figs., and the bottom wall 32 is formed with a groove 56, all of which align with the slot 50. Each of the grooves 54 and 56 extend from the inner surface 46 of their respective walls toward the outer surface 48 thereof. The sign 40 is inserted through the slot 50 in the top wall 30, and then slides within each of the grooves 54 and 56 to retain it in place within the hollow interior 38 of the frame 12. Preferably, one of the sections 51 or 53 of the top wall 30 is formed with a number of spaced extensions 58 which face the opposite section thereof and engage the sign 40 to prevent it from slipping out of the frame 12. The sign 40 is therefor captured along its side edges and bottom edges within the grooves 54 and 56, respectively, and along the top edge by the extensions 58. The two sections 51,53 forming the top wall 30 can be readily pried apart to remove the sign 40, and replace it with another.

One aspect of this invention is the provision of cooperating structure on the frame 12 and adapter 14 to permit the adapter 14 to mount to the frame 12 and slide to essentially any position along its walls 30, 32, 34 or 36. In the presently preferred embodiment, each of the walls 30, 32, 34 and 36 is formed with a first channel 60 extending from its front surface 42 toward the back surface 44, and a second channel 62 beginning at the back surface 44 and extending in a direction toward the front surface 42. The first and second channels 60, 62 align with one another and span the entire length of each wall 30, 32, 34 and 36, but extend only partially into the thickness thereof.

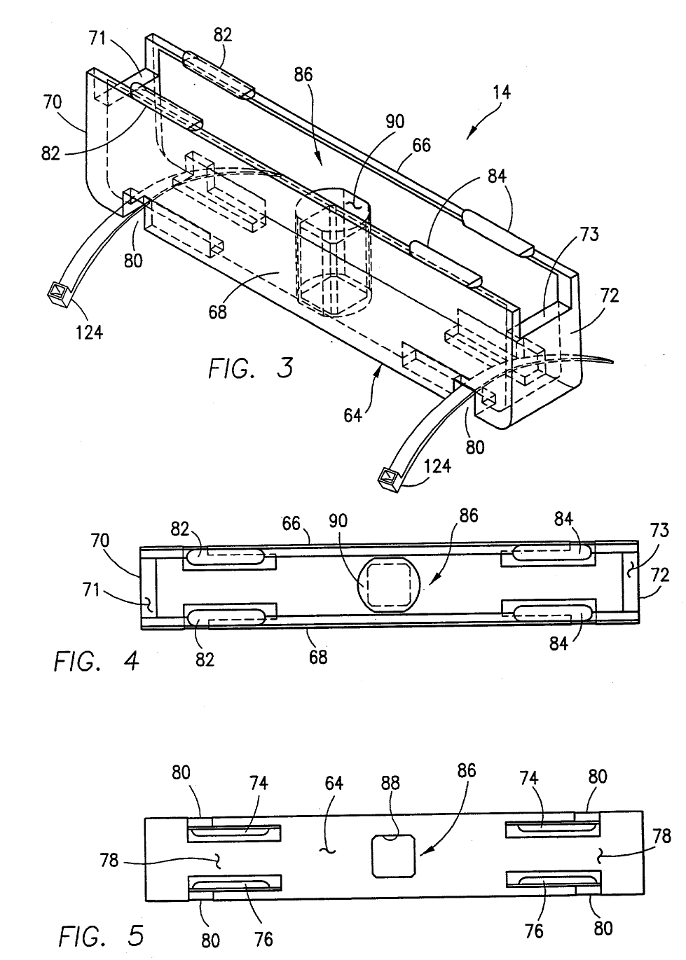

Referring now to FIGS. 3-6, the adapter 14 comprises a base 64, a pair of spaced legs 66 and 68 connected on either side of the base 64 and opposed end walls 70 and 72 each connected to the base 64 and to the legs 66, 68. Each of the end walls 70, 72 has an exposed, upper edge 71 and 73, respectively. The base 64 is formed with a pair of spaced slots 74 and 76 at either end, which define a segment 78 therebetween. Each of the legs 66 and 68 has a notch 80, which intersect the slots 74, 76, for purposes to become apparent below. The upper edge of each leg 66 and 68 opposite the base 64 is formed with spaced tabs 82 and 84. The tabs 82 and 84 are longitudinally spaced from one another along the length of each leg 66 and 68, e.g. in a direction from one end wall 70 to the other end wall 72, and, the tabs 82 and 84 mounted on leg 66 align with and are spaced from the respective tabs 82 and 84 on the leg 68. A socket 86 is located internally of the adapter 14, which is generally cylindrical in shape and has an open end 88 at the base 64 and a closed end 90. As best seen in FIG. 3, the upper edge 71 and 73 of the end walls 70, 72, and closed end 90 of the sleeve 86, are located in substantially the same plane and are spaced from the tabs 82, 84. Although the exterior of the socket 86 is cylindrical, its open end 88 has a generally square cross section to receive the squared ends of connectors 24, 26 and 28, as discussed below.

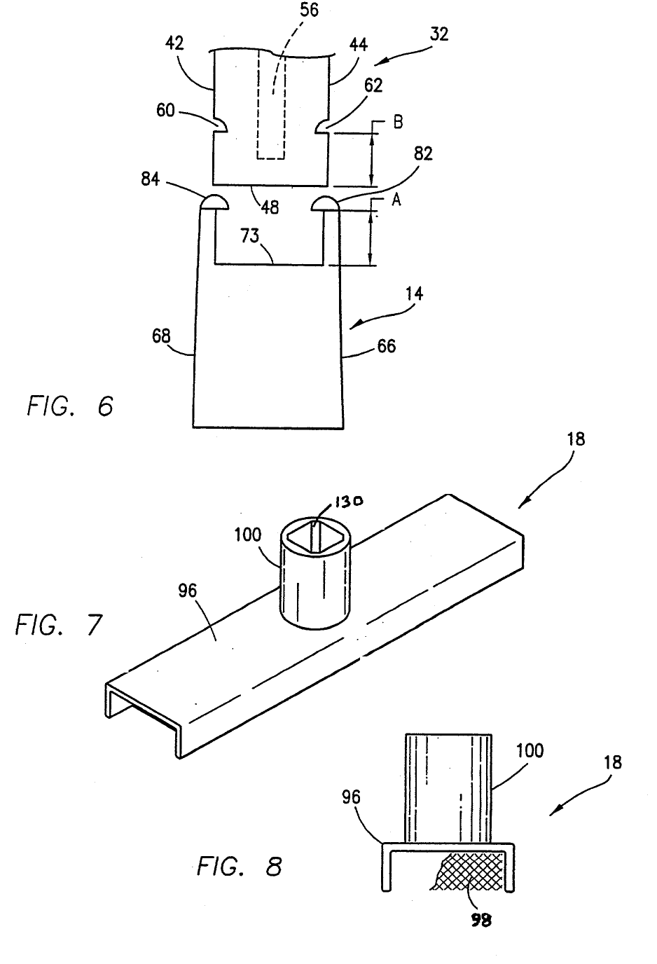

The frame 12 and adapter 14 are slidably interconnected as follows. The adapter 14 is placed in the orientation shown in FIGS. 1 and 2, so that the tabs 82 and 84 on the leg 68 align with the first channel 60 in one of the walls, e.g., the bottom wall 32 for purposes of illustration, and so that the tabs 82 and 84 on the leg 66 align with the second channel 62 on the opposite side of the bottom wall 32. The tabs 82 and 84 slide within the channels 60 and 62 while the outer surface 48 of the bottom wall 34 frictionally engages the edges 71, 73 of the end walls 70, 72 of the adapter 14, as well as the closed end 90 of its sleeve 86. As depicted in FIG. 6, the space “A” between the tabs 82, 84 and the upper edge 73 of end wall 72, and as well as the upper edge 71 of end wall 70 and the closed end 90 of sleeve 86, is slightly less than the distance “B” between the bottom of the first and second channels 60, 62 and the outer surface 48 of side wall 34. This dimensional relationship allows the adapter 14 to slide along the side wall 34 but with sufficient frictional engagement to retain the adapter 14 in place at any location along the side wall 34. Additionally, the thickness or depth of the bottom wall 32, as measured between its front surface 42 and back surface 44, is approximately equal to the distance between the legs 66 and 68 of the adapter 14 to further assist with the retention of the adapter 14 on the bottom wall 32. It should be understood that while the connection between the frame 12 and adapter 14 has been described with reference to bottom wall 32, each of the other walls 30, 34 and 36 are connected to the adapter 14 in the same manner. Consequently, the adapter 14 can be positioned along the frame 12 at any desired location, and maintained in place due to the frictional engagement between the adapter 14 and frame walls 30, 32, 34 or 36, as described above.

Referring now to FIGS. 1 and 7-12, the frame 12 and adapter 14 are depicted in combination with the fixtures 16-22, each of which are intended for use with a different type of merchandise display. As shown in FIG. 1, the shovel base 16 consists of a base plate 92 and a sleeve 94 extending outwardly therefrom. The frame 12 and adapter 14 are connected to the shovel base 16 by inserting an end of one of the connectors or posts 24-28 into the socket 86 of adapter 14 and the opposite end into the sleeve 94 of shovel base 16. The open end of sleeve 94 has a generally square cross section to receive the post 28, as does the open end 88 of socket 86 noted above. The adapter 14 may be positioned along any wall 30-36 of the frame 12 to orient the sign 40 carried by the frame 12 as desired.

As shown in FIGS. 7 and 8, the magnetic fixture 18 is formed in a U-shaped channel 96 having an interior which mounts a magnet 98. The exterior of the channel 96 supports a sleeve 100 having a generally square-shaped interior to mount the free end of a connector 24-28, the opposite end of which is received within the socket 86 of the adapter 14. Conventionally, the magnetic fixture 18 can be connected to a metal surface such as a shelf or the like to place the frame 12 and its sign 40 in close proximity to the articles displayed on the shelf.

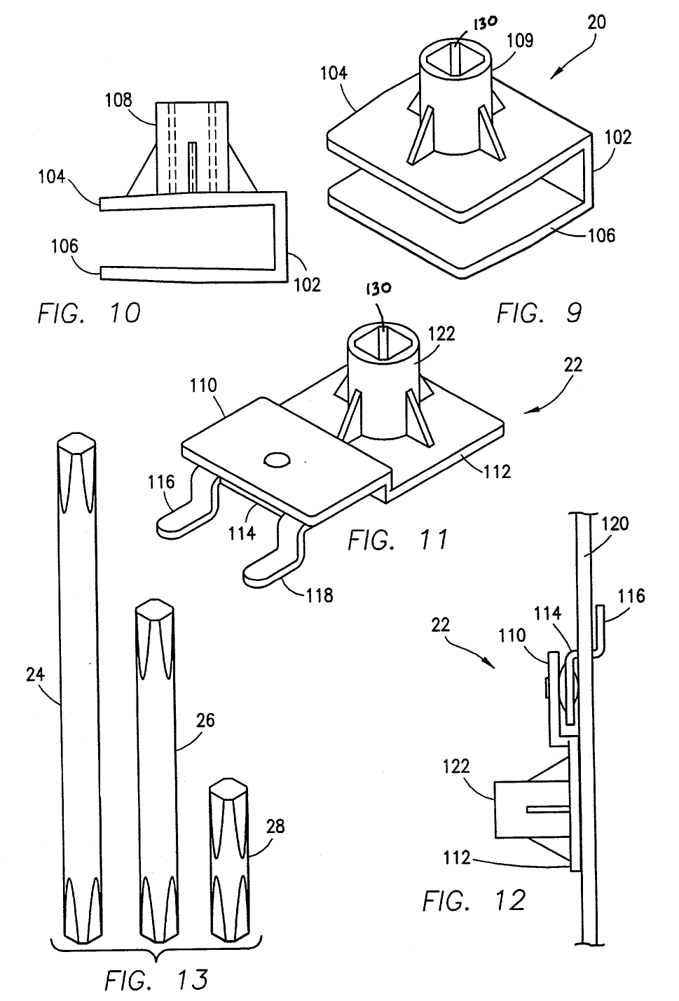

Referring to FIGS. 9 and 10, the jet rail fixture 20 is intended for use with a rack or similar type of display having bars or arms to support items to be displayed. The jet rail fixture 20 includes an end wall 102 connected at each edge to one of a pair of side walls 104 and 106. The space between the side walls 104, 106 permits the fixture 20 to be snap fitted onto a bar or the like of a display rack (not shown). A sleeve 108 extends outwardly from the side wall 104 of fixture 18, having a generally square-shaped interior to receive one end of a connector or post 24-28, the other end of which mounts to the socket 86 of adapter 14.

With reference to FIGS. 11 and 12, the pegboard/slatwall fixture 22 includes a top portion 110 connected to an offset, bottom portion 112. The top portion 110 mounts a plate 114 having a pair of hooks 116 and 118 shaped to be inserted within the holes of a pegboard 120 or the channels of a slatwall (not shown). The bottom portion 112 carries a sleeve 122 having a generally square-shaped interior to mount the free end of a connector or post 24-28 extending from the socket 86 of the adapter 14.

Additionally, as shown in FIG. 3, the frame 12 and adapter 16 can be mounted to a merchandise display (not shown) by a strip 124 formed of plastic or the like. The strip 124 is inserted through the notch 80 in one of the adapter legs 66 or 68, wrapped around the segment 78 formed between the adjacent slots 74, 76 in the base of adapter 14 and then secured around a bar or other element of a display. The connector strip 126 thus functions as a “fixture” in a manner similar to the fixtures 16-22.

With the adapter 14 in a selected position along any of the walls 30-36 of the frame 12, one of the connectors or posts 24-28 is inserted into the socket 86 of the adapter 14. The free end of one of the posts 24-28 is then connected to a corresponding sleeve of one of the fixtures 16-22 as described above. Alternatively, the strip 124 is employed to secure the adaptor 14 and frame 12 to a display. In this manner, the same frame 12 and adapter 14 can be used with a variety of merchandise displays, with the only change being the type of fixture 16-22 or strip 124 employed for the particular display. This greatly simplifies the placement of signs 40 around a retail outlet or other store, reduces the inventory of parts which must be stored and reduces costs in the purchase of the sign holder of this invention.

While the invention has been described with referenced to a preferred embodiment, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

For example, the sleeves 94, 100, 109 and 122 of the fixtures 16, 18, 20 and 22, respectively, are depicted with a generally square-shaped interior formed with grooves 130 shaped to receive the tapered ends of posts 24, 26 and 28. See FIGS. 7, 9 and 11. It is contemplated that alternative function-type connections would be equally suitable for mounting the fixtures and posts.

Therefore, it is intended that the invention not be limited to the particular embodiment disclosed as the best mode contemplated for carrying out this invention, but that the invention will include all embodiments falling within the scope of the appended claims.

What is claimed is:

1. A universal sign holder, comprising:
a frame including a wall having spaced inner and outer surfaces and having spaced front and back surfaces each extending between said inner and outer surfaces, said inner surface of said wall defining a hollow interior within which a sign is mounted, said wall being formed with at least one channel extending from said front surface in a direction toward said back surface;
an adapter which engages and slides within said at least one channel to a selected position along said wall of said frame;
a fixture adapted to mount to a merchandise display;
a connector extending between said adapter and said fixture to position said frame in proximity to the merchandise display.

2. The universal sign holder of claim 1 in which said wall of said frame comprises a top wall, a bottom wall and opposed side walls all interconnected to form said hollow interior, each of said bottom wall and said side walls having spaced inner and outer surfaces and being formed with a groove extending from said inner surface toward said outer surface.

3. The universal sign holder of claim 2 in which said top wall includes inner and outer surfaces, said top wall being formed with a slot extending through said inner and outer surfaces to permit the insertion of a sign therethrough, said sign being received and retained within said grooves formed in each of said bottom wall and said opposed side walls of said frame.

4. The universal sign holder of claim 1 in which said adapter includes a base, a pair of spaced legs extending outwardly from said base and a pair of spaced ends connected to said base and to said legs, at least one of said legs mounting at least one tab which is insertable within said at least one channel formed in said wall of said frame.

5. The universal sign holder of claim 4 in which said at least one channel formed in said wall comprises a first channel extending from said front surface toward said back surface, and a second channel extending from said back surface toward said front surface and which is spaced from said first channel, each of said first and second channels being spaced from said outer surface of said wall.

6. The universal sign holder of claim 5 in which each of said legs of said adapter is formed within a pair of tabs spaced from one another in a lengthwise direction along said legs, one pair of said tabs being insertable within said first channel and the other pair of said tabs being insertable within said second channel.

7. The universal sign holder of claim 5 in which said adapter is formed with a socket extending outwardly from said base, said socket having an open end at said base and a closed end which is spaced from said tabs, said space between said closed end of said socket and said tabs on each of said legs of said adapter being slightly greater than said space between said first and second channels and said outer surface of said wall so that upon insertion of said tabs within said first and second channels said wall is frictionally retained between said tabs and said closed end of said socket of said adapter.

8. The universal sign holder of claim 7 in which each of said spaced ends of said adaptor is formed within an upper edge, said upper edge of each said spaced ends being co-planar with said closed end of said socket to frictionally engage said wall of said frame upon insertion of said tabs within said first and second channels.

9. The universal sign holder of claim 7 in which said connector is a post, a first end of said post being insertable within said socket of said adapter.

10. The universal sign holder of claim 9 in which said fixture is formed with a sleeve, said post having a second end insertable within said sleeve of said fixture.

11. The universal sign holder of claim 4 in which one of said base and said spaced legs is formed with an opening, a strip being insertable through said opening to mount said adapter to a merchandise display.

12. The universal sign holder of claim 1 in which said fixture includes a plate and a sleeve extending outwardly from said plate, said connector having a first end insertable within said sleeve.

13. The universal sign holder of claim 1 in which said fixture includes a generally U-shaped channel, a magnet being mounted within said channel and a sleeve extending outwardly from said channel opposite said magnet, said connector having a first end insertable within said sleeve.

14. The universal sign holder of claim 1 in which said fixture includes an end wall and a pair of spaced side walls extending outwardly from said end wall, said side walls being adapted to mount to a rail within a merchandise display, one of said side walls mounting a sleeve which connects to one end of said connector.

15. The universal sign holder of claim 1 in which said fixture includes a bottom portion and a top portion, said bottom portion mounting a sleeve which receives one end of said connector, said top portion mounting at least one hook which is adapted to be inserted within at least one opening in at least one of a pegboard or a slatwall.

16. The universal sign holder of claim 1 in which said connector comprises a number of individual posts each having a different length, each of said posts having at least one end shaped to frictionally engage a sleeve formed in said fixture.

17. A universal sign holder, comprising:
a frame including a wall having spaced inner and outer surfaces and having spaced front and back surfaces each extending between said inner and outer surfaces, said inner surface of said wall defining a hollow interior within which a sign is mounted, said wall being formed with a first channel extending from said front surface toward said back surface and a second channel extending from said back surface toward said front surface, each of said first and second channels being spaced from said outer surface of said wall;
an adapter including a base and a pair of spaced legs extending outwardly from said base, each of said legs being formed with at least one tab, said at least one tab of one leg extending toward said at least one tab of the other leg, one of said at least one tabs being insertable within said first channel and the other of said at least one tabs being insertable within said second channel to position such adapter along said wall of such frame;
a fixture adapted to mount to a merchandise display;
a connector extending between said adapter and said fixture to position said frame in proximity to the merchandise display.

18. The universal sign holder of claim 17 in which said wall of said frame comprises a top wall, a bottom wall and opposed side walls all interconnected to form said hollow interior, each of bottom wall and said side walls having spaced inner and outer surfaces and being formed with a groove extending from said inner surface toward said outer surface.

19. The universal sign holder of claim 18 in which said top wall includes inner and outer surfaces, said top wall being formed with a slot extending through said inner and outer surfaces to permit the insertion of a sign therethrough, said sign being received and retained within said grooves formed in each of said bottom wall and said opposed side walls of said frame.

20. The universal sign holder of claim 17 in which said adapter is formed with a socket extending outwardly from said base, said socket having an open end at said base and a closed end which is spaced from said tabs, said space between said closed end of said socket and said tabs on each of said legs of said adapter being slightly greater than said space between said first and second channels and said outer surface of said wall so that upon insertion of said tabs within said first and second channels said wall is frictionally retained between said tabs and said closed end of said socket of said adapter.

21. The universal sign holder of claim 20 in which each of said spaced ends of said adaptor is formed within an upper edge, said upper edge of each said spaced ends being co-planar with said closed end of said socket to frictionally engage said wall of said frame upon insertion of said tabs within said first and second channels.

22. The universal sign holder of claim 17 in which said connector is a post, a first end of said post being insertable within said socket of said adapter.

23. The universal sign holder of claim 22 in which said fixture is formed with a sleeve, said post having a second end insertable within said sleeve of said fixture.

24. The universal sign holder of claim 17 in which one of said base and said spaced legs is formed with an opening, a strip being insertable through said opening to mount said adapter to a merchandise display.

25. The universal sign holder of claim 17 in which said fixture includes a plate and a sleeve extending outwardly from said plate, said connector having a first end insertable within said sleeve.

26. The universal sign holder of claim 17 in which said fixture includes a generally U-shaped channel, a magnet being mounted within said channel and a sleeve extending outwardly from said channel opposite said magnet, said connector having a first end insertable within said sleeve.

27. The universal sign holder of claim 17 in which said fixture includes an end wall and a pair of spaced side walls extending outwardly from said end wall, said side walls being adapted to mount to a rail within a merchandise display, one of said side walls mounting a sleeve which connects to one end of said connector.

28. The universal sign holder of claim 17 in which said fixture includes a bottom portion and a top portion, said bottom portion mounting a sleeve which receives one end of said connector, said top portion mounting at least one hook which is adapted to be inserted within at least one hole in a pegboard.

29. The universal sign holder of claim 17 in which said connector comprises a number of individual posts each having a different length, each of said posts having at least one end shaped to frictionally engage a sleeve formed in said fixture.
